(19) United States
(12) Patent Application Publication
(10) Pub. No.: US 2010/0171725 A1
(43) Pub. Date: Jul. 8, 2010

(54) METHOD OF DRIVING SCAN LINES OF FLAT PANEL DISPLAY

(76) Inventors: Chi-Chung Tsai, Kinmen County (TW); Wen-Chih Tai, Taoyuan County (TW); Chia-Lin Liu, Taichung County (TW); Chi-Neng Mo, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/509,499

(22) Filed: Jul. 27, 2009

(30) Foreign Application Priority Data
Jan. 6, 2009 (TW) 098100160

(51) Int. Cl. G09G 5/00; G09G 3/20

(52) U.S. Cl. 345/205; 345/55

(57) ABSTRACT

A method of driving scan lines of a flat panel display uses a gate clock signal, a gate start signal, and an output enabling signal to generate gate signals turning on two scan lines at the same time. The gate clock signal has a first group of clocks and a second group of clocks. The gate start signal has two pulses. The plurality of gate signals for controlling a plurality of scan lines are generated in sequence according to the gate clock signal and the gate start signal, and each gate signal has two pulses. The pulse of each gate signal in the first group of clocks is disabled and the pulse of each gate signal in the second group of clocks is outputted according to the output enabling signal. Thus, the plurality of gate signals can turn on two scan lines at the same time.

### BACKGROUND OF THE INVENTION

1. Field of the Invention

The present invention relates to a method of driving scan lines of a flat panel display, and more particularly, to a method of driving a flat panel display by turning on two scan lines at the same time.

2. Description of the Prior Art

Please refer to FIG. 1. FIG. 1 is a diagram illustrating a conventional flat panel display. The flat panel display 10 comprises a gate driver 12, a source driver 14 and a display panel 16. The flat panel display 10 can be an Active-Matrix Liquid Crystal Display (AMLCD), an Organic Light-Emitting Diode (OLED) display, or a Plasma Display Panel (PDP). The display panel 16 comprises a plurality of pixels 18. The plurality of pixels 18 are interwoven by the plurality of scan lines G1˜GM and the plurality of data lines S1˜SN. Furthermore, the plurality of pixels 18 are electrically connected to the gate driver 12 through a plurality of scan lines G1˜GM, and the plurality of pixels 18 are electrically connected to the source driver 14 through a plurality of data lines S1˜SN. The scan lines G1˜GM are utilized for turning on the plurality of pixels 18, and the data lines S1˜SN are utilized for outputting the data voltage level to the plurality of pixels 18.

Please refer to FIG. 2. FIG. 2 is a waveform diagram of control signals of a conventional gate driver 12. When displaying the image, in the date driver 12, a gate clock signal CPV is generated for transmitting and outputting a gate start signal STV in sequence to each output channel of the gate driver 12, and then the gate start signal STV is outputted in sequence for turning on each scan line through the output channels of the gate driver 12. When a scan line is scanned, the scan line outputs a pulse for turning on the pixels electrically connected to the scan line, and the data lines S1˜SN output the data voltage level to the turned-on pixels respectively so as to display the image. In addition, each time before a scan line outputs a pulse, an output enabling signal OE is transmitted to the gate driver 12 for disable the output channels of gate driver 12. In this way, it can be assure that at most a scan line is turned on at any time so as to avoid the crosstalk effect. More precisely, at most a scan line is turned on at any time so that only the pixels corresponding to the scan line is turned on at that time for receiving the data voltage level.

Generally speaking, in the flat panel display 10, the entire image is scanned sixty times a second (The period of scanning the entire image one time is called a frame time hereinafter). In other words, a frame time is one-sixth second. During each frame time, the scan lines G1˜GM are all scanned (turned on) in sequence. When a scan line is scanned, the source driver 14 of the flat panel display 10 determines the output voltage level of the data lines S1˜SN according to the display data corresponding to the pixels turned on by the scan line, and the rest scan lines remain turned-off. Thus, all the pixels turned on by the scan line can be written the image data at the time. The above-mentioned scan operation will be repeated again and again until all of the scan lines G1˜GM are scanned for displaying the entire image. However, it is noticeable that, for avoiding the crosstalk effect, the conventional flat panel display 10 can drive at most one scan line at any time. That is, the conventional flat panel display 10 is incapable of driving two or more scan lines at the same time.

When the gate driver 12 executes the above-mentioned scan operation, not only the period of charging or discharging the capacitor of the pixels 18 have to be long enough, but also the period of the source driver 14 outputting the data have to be sufficient. If a scan line is turned on before a data line has finished outputting data, the capacitors of the plurality of pixels 18 are affected by the unexpected image data, causing the image displayed by the flat panel display 10 appears the phenomenon of attenuation. In a similar situation, when the period of charging the capacitors of the pixels 18 is not long enough, the capacitors of the pixels 18 cannot be charged to the required voltage level so that the image displayed by the flat panel display 10 appears the phenomenon of attenuation as well. Therefore, for avoiding the phenomenon of attenuation, the gate driver 12 and the source driver 14 have to correctly control the time sequence of transmitting signals to the scan lines G1˜GM and the data lines S1˜SN. As the resolution of flat panel displays increases, the number of the scan lines and data lines increase as well, so that more scan lines are required to be scanned during a frame time. Hence, the period of turning on a scan line is reduced, and the period of charging the capacitors of the pixels 18 is reduced as well.

### SUMMARY OF THE INVENTION

It is therefore an objective of the claimed invention to provide a method of driving scan lines of a flat panel display for solving the above-mentioned problem.

According to an embodiment of the present invention, a method of driving scan lines of a flat panel display comprises generating a gate clock signal having a first group of clocks and a second group of clocks, generating a gate start signal having two pulses, generating a plurality of gate signals in sequence for controlling a plurality of scan lines of the flat panel display according to the gate clock signal and the gate start signal, each gate signal having two pulses, disabling the pulse of each gate signal in the first group of the clocks and outputting the pulse of each gate signal in the second group of the clocks according to an output enabling signal, and turning on two scan lines of the plurality of the scan lines during the same period according to the plurality of the gate signals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional flat panel display.

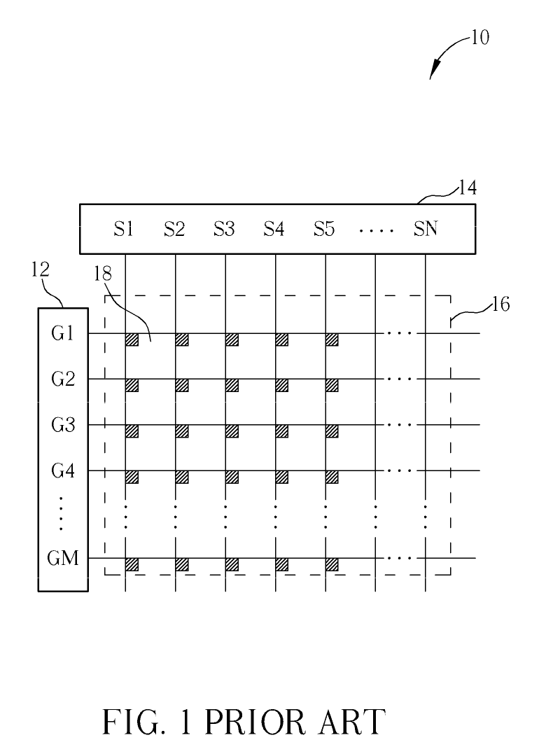

FIG. 2 is a waveform diagram of control signals of a conventional gate driver.

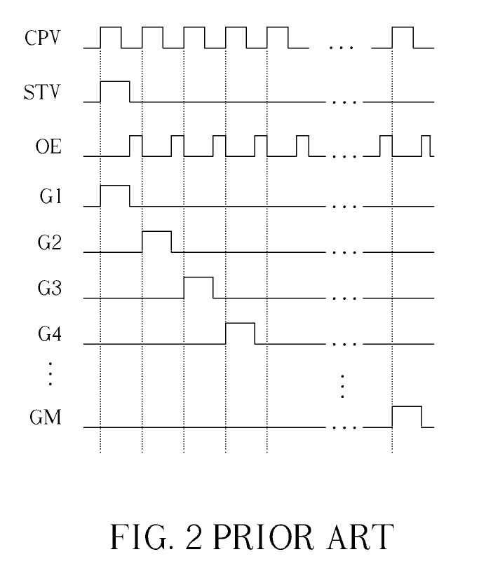

FIG. 3 is a waveform diagram of control signals of a gate driver according to a first embodiment of the present invention.

FIG. 4 is a diagram illustrating a flat panel display controlled by the control signals shown in FIG. 3.

FIG. 5 is a waveform diagram of control signals of a gate driver according to a second embodiment of the present invention.

FIG. 6 is a waveform diagram of control signals of a gate driver according to a third embodiment of the present invention.

FIG. 7 is a diagram illustrating a flat panel display controlled by the control signals shown in FIG. 6.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ” Also, the term “electrically connect” is intended to mean either an indirect or direct electrical connection. Accordingly, if one device is coupled to another device, that connection may be through a direct electrical connection, or through an indirect electrical connection via other devices and connections.

The present invention provides a method of driving a general flat panel display having a general gate driver by turning on a plurality of scan lines at the same time for increasing the scan speed of the flat panel display.

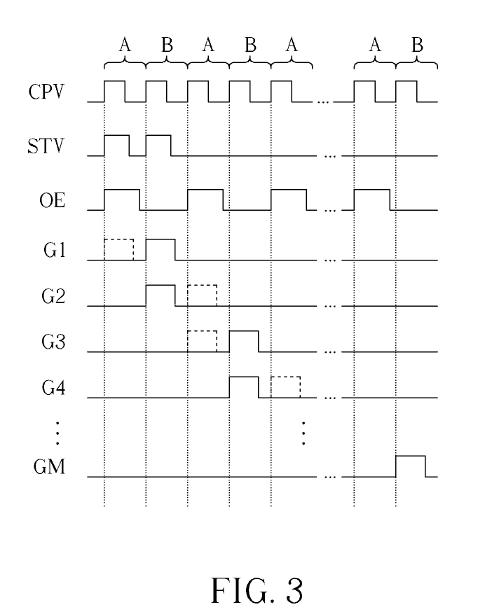

Please refer to FIG. 3. FIG. 3 is a waveform diagram of control signals of a gate driver capable of turning on two scan lines at the same time, according to a first embodiment of the present invention. General flat panel display comprises a gate driver, a source driver and a display panel. The gate driver generates gate signals for turning on a plurality scan lines of the display panel, by means of a gate clock signal CPV, a gate start signal STV, and an output enabling signal OE. The gate clock signal CPV is utilized for providing the synchronous clock to the gate signals. The gate clock signal STV is utilized for providing the start pulse (trigger signal) to the gate signals, so that the gate start signal STV determines when the pulses of the gate signals are triggered, and how many pulses of the gate signals are triggered. The output enabling signal OE is utilized for determining if the gate signals can be outputted to the corresponding scan lines from the output channels of the gate driver.

According to the present invention, the method of driving the flat panel display utilizes the gate clock signal CPV, the gate start signal STV, and the output enabling signal OE for generating the gate signals capable of turning on a plurality of scan lines at the same time. In the embodiments of the present invention, the gate signals capable of turning on two scan lines at the same time are illustrated as an example.

As shown in FIG. 3, the gate clock signal CPV has a first group of clocks A and a second group of clocks B. The gate start signal STV has two pulses. A plurality of gate signals G1˜GM for controlling a plurality of scan lines are generated in sequence according to the gate clock signal CPV and the gate start signal STV, wherein each gate signal has two pulses because the gate start signal STV has two pulses. According to the output enabling signal OE, the pulse of each gate signal in the first group of the clocks A is disabled and the pulse of each gate signal in the second group of the clocks B is outputted. As a result, two scan lines are turned on by the plurality of gate signals during the same period (the second group of the clocks B). In FIG. 3, when the output enabling signal OE is at the high voltage level, the pulse of each gate signal in the first group of the clocks A is disabled. When the output enabling signal OE is at the low voltage level, the pulse of each gate signal in the second group of the clocks B is outputted.

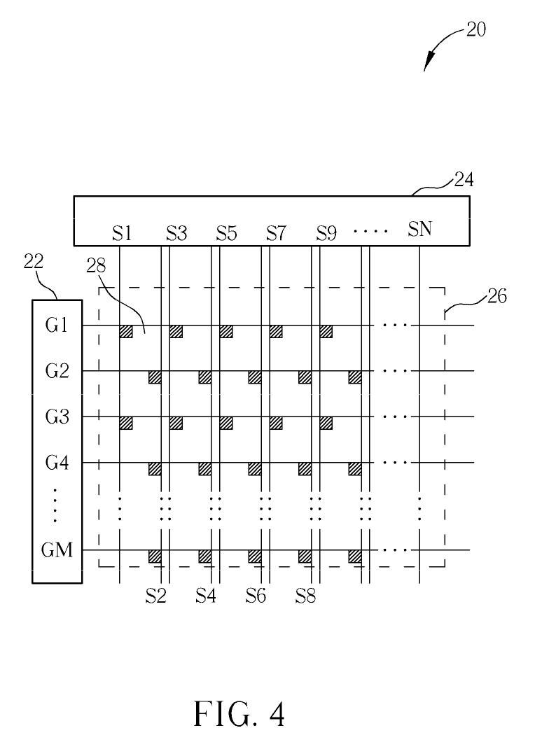

Please refer to FIG. 4, FIG. 4 is a diagram illustrating a flat panel display 20 controlled by the control signals shown in FIG. 3. The flat panel display 20 comprises a gate driver 22, a source driver 24 and a display panel 26. The display panel 26 comprises a plurality of pixels 28. The plurality of the pixels 28 is electrically connected to the gate driver 22 through a plurality of scan lines G1˜GM, and is electrically connected to the source driver 24 through a plurality of data lines S1˜SN. The scan lines G1˜GM are divided into odd scan lines (G1, G3, G5 and so on) and even scan lines (G2, G4, G6 and so on). The data lines S1˜SN are divided into odd data lines (S1, S3, S5 and so on) and even data lines (S2, S4, S6 and so on). According to the gate signals shown in FIG. 3, two scan lines of the flat panel display 20 are turned on at the same time in the second groups of the clocks B, wherein one of the two scan lines is an odd scan and the other one is an even scan line, so the different data are transmitted through two corresponding data lines for displaying different gray levels of the pixels so as to shorten the scan period. In this embodiment, for avoiding the crosstalk effect, among the plurality of the pixels 28, a pixel electrically connected to an odd scan line is electrically connected to an odd data line, and a pixel electrically connected to an even scan line is electrically connected to an even data line.

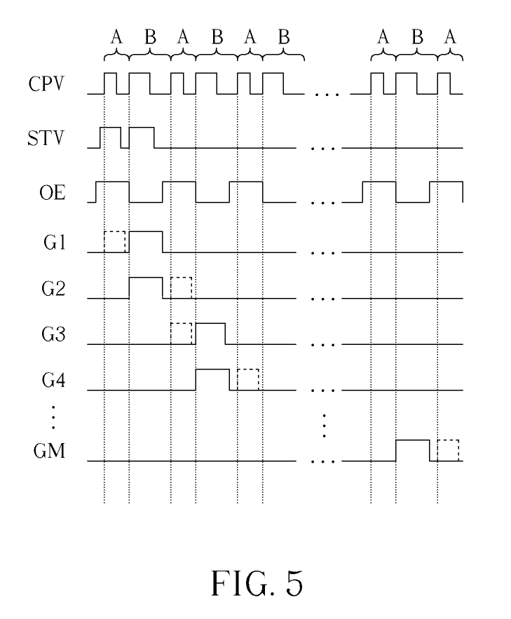

Please refer to FIG. 5. FIG. 5 is a waveform diagram of control signals of a gate driver capable of increasing the scan speed of a flat panel display, according to a second embodiment of the present invention. Like the control signals shown in FIG. 3, the control signals shown in FIG. 5 are utilized for driving the flat panel display 20. The difference between the control signals shown in FIG. 3 and the control signals shown in FIG. 5 is that the period length of the first group of the clocks A equals to the period length of the second group of the clocks B in FIG. 3, and the period length of the first group of the clocks A is shorter than the period length of the second group of the clocks B in FIG. 5 for increasing the scan speed. Furthermore, each scan line is turned on only one time during a frame time.

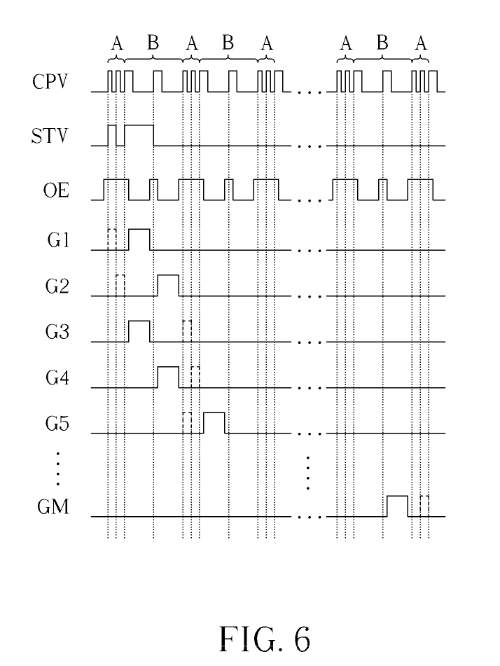

Please refer to FIG. 6. FIG. 6 is a waveform diagram of control signals of a gate driver according to a third embodiment of the present invention. The gate clock signal CPV has a first group of clocks A and a second group of clocks B. The gate start signal STV has two pulses. The output enabling signal OE is turned off (at the high voltage level) in the first group of the clocks A, and the output enabling signal OE is turned on (at the low voltage level) in the second group of the clocks B. In addition, in consideration of the crosstalk effect, the turn-on period of the output enabling signal OE is adjusted. The pulse of each gate signal in the first group of the clocks A is disabled. Two scan lines are turned on in the second group of the clocks B by the gate signals and the different data are transmitted through two corresponding data lines. Since each time two scan lines are simultaneously turned on, two different groups of data lines are required for transmitting the display data to the pixels electrically connected to two scan lines, respectively. In other words, the required number of data lines is twice as large as the number of pixels electrically connected to two scan lines. For instance, in the display panel of 1024×768-pixel resolution, there are scan lines G1˜G768. Since there are 1024 pixels in a row in the display panel, the required number of data lines is 2048. The period length of the second group of the clocks B of the gate clock signal CPV is determined by the required period length of charging the capacitor of the pixel. However, the period length of the first group of the clocks A of the gate clock signal CPV is designed as short as possible according to the limit of the gate driver for increasing the scan speed. In this way, the frame time of the flat panel display is almost reduced by half.

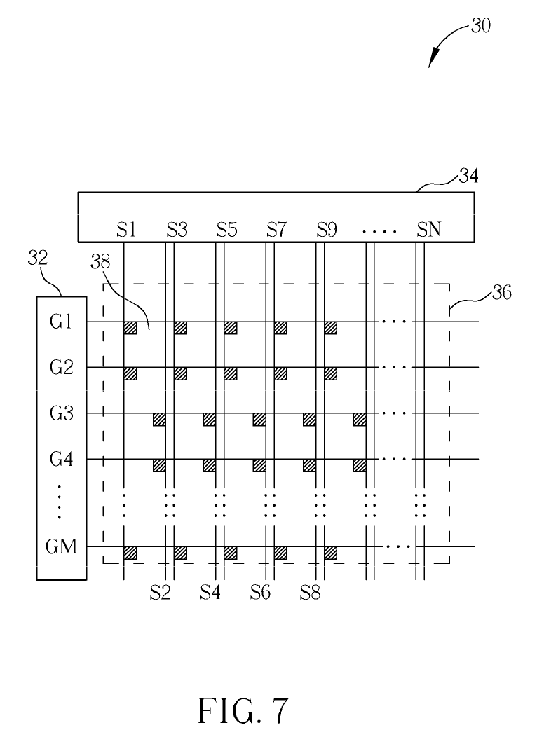

Please refer to FIG. 7. FIG. 7 is a diagram illustrating a flat panel display 30 controlled by the control signals shown in FIG. 6. The flat panel display 30 comprises a gate driver 32, a source driver 34 and a display panel 36. The data lines S1˜SN are divided into odd data lines (S1, S3, S5 and so on) and even data lines (S2, S4, S6 and so on). According to the gate signals in FIG. 6, since two scan lines are simultaneously turned on during the same period, two different groups of data lines are required for transmitting the display data to the pixels electrically connected to two scan lines, respectively. For example, in the present invention, the scan line G1 and G3 are turned on at the same time, the pixels 38 electrically connected to the scan line G1 are electrically connected to the odd data lines, and the pixels 38 electrically connected to the scan line G3 are electrically connected to the even data lines. The scan line G2 and G4 are turned on at the same time, the pixels 38 electrically connected to the scan line G2 are electrically connected to the odd data lines, and the pixels 38 electrically connected to the scan line G4 are electrically connected to the even data lines.

Please refer to FIG. 6 again. For instance, of the clocks of the gate clock signal CPV, the first and the second clock is utilized for transmitting the gate start signal STV. The third clock is utilized for turning on the scan lines G1 and G3 and the fourth clock is utilized for turning on the scan lines G2 and G4, wherein the period of turning on a scan line actually is the period of charging pixels electrically connected to the scan line. The fifth clock is utilized for bypassing a pulse of the scan line G3 and a pulse of the scan line G5. The sixth clock is utilized for bypassing a pulse of the scan line G4 and a pulse of the scan line G6. The seventh clock is utilized for turning on the scan lines G5 and G7 and the eighth clock is utilized for turning on the scan lines G6 and G8. Hence, the output enabling signal OE disabled the first, the second, the fifth, the sixth, the ninth, and the tenth clocks of the gate clock signal CPV and so on. The output enabling signal OE enables the third, the fourth, the seventh, the eighth, the eleventh, and the twelfth clocks of the gate clock signal CPV and so on.

In conclusion, according to the present invention, the method of driving a flat panel display by turning on a plurality of scan lines at the same time can increase the scan speed of the flat panel display, and the method can be applied by a general gate driver and a general source driver. According to the method of the present invention, a gate clock signal having a first group of clocks and a second group of clocks, and a gate start signal having two pulses are generated. A plurality of gate signals for controlling a plurality of scan lines of the flat panel display is generated in sequence. Each gate signal has two pulses. According to an output enabling signal, the pulse of each gate signal in the first group of the clocks is disabled and the pulse of each gate signal in the second group of the clocks is outputted. Therefore, the plurality of the gate signals can turn on two scan lines of the plurality of the scan lines during the same period. The driving method according to the present invention can be utilized in the flat panel display of color sequential method, wherein the flat panel display includes a backlight source having a red light source, a green light source, and a blue light source. In this way, in the flat panel display, the period of scanning and charging the pixels can be reduced for improving the color-mixing problem due to the overlapped period of charging different pixels, so as to increase the color saturation and the color uniformity. In addition, the picture clarity of the flat panel display other than the flat panel display of color sequential method can be improved by means of the driving method according to the present invention.

Those skilled in the art will readily observe that numerous modifications and alterations of the device and method may be made while retaining the teachings of the invention.

What is claimed is:

1. A method of driving scan lines of a flat panel display, comprising:
generating a gate clock signal having a first group of clocks and a second group of clocks;
generating a gate start signal having two pulses;
according to the gate clock signal and the gate start signal, generating a plurality of gate signals in sequence for controlling a plurality of scan lines of the flat panel display, each gate signal having two pulses;
according to an output enabling signal, disabling the pulse of each gate signal in the first group of the clocks and outputting the pulse of each gate signal in the second group of the clocks; and
according to the plurality of the gate signals, turning on two scan lines of the plurality of the scan lines during the same period.

2. The method of claim 1, wherein according to the plurality of the gate signals turning on two scan lines of the plurality of the scan lines during the same period, comprising:
turning on a first scan line and turning on a second scan line at the same time, for turning on a first row of pixels electrically connected to the first scan line and turning on a second row of pixels electrically connected to the second scan line; and
using a first group of data lines for transmitting a first row of display data to the first row of the pixels, and using a second group of data lines for transmitting a second row of display data to the second row of the pixels.

3. The method of claim 1, wherein according to the plurality of the gate signals turning on two scan lines of the plurality of the scan lines during the same period, comprising:
dividing a frame time into a plurality of periods; and
turning on two scan lines of the plurality of the scan lines during each of the plurality of the periods;
wherein each of the plurality of the scans line is turned on only one time during the frame time.

4. The method of claim 1, wherein generating the gate clock signal having a first group of clocks and the second group of clocks, the period length of the first group of the clocks is shorter than the period length of the second group of the clocks.

5. The method of claim 1, wherein according to the output enabling signal, disabling the pulse of each gate signal in the first group of the clocks and outputting the pulse of each gate signal in the second group of the clocks, comprising:
disabling the pulse of each gate signal in the first group of the clocks when the output enabling signal is at the high voltage level; and
outputting the pulse of each gate signal in the second group of the clocks when the output enabling signal is at the low voltage level.

6. The method of claim 1, wherein the flat panel display comprises a backlight module having a red light source, a green light source and a blue light source.

7. The method of claim 1, wherein each column of pixels of the flat panel display are transmitted display data by two data lines.

8. The method of claim 1, wherein the flat panel display is an Active-Matrix Liquid Crystal Display (AMLCD), an Organic Light-Emitting Diode (OLED) display, or a Plasma Display Panel (PDP).

9. The method of claim 1, further comprises:
determining when the pulses of the gate signals are triggered, and how many pulses of the gate signals are triggered according to the gate start signal.

10. The method of claim 1, further comprises:
determining an interval between two pulses of each gate signal according to the gate clock signal.
